(19) United States
(12) Patent Application Publication
(10) Pub. No.: US 2006/0221240 A1
(43) Pub. Date: Oct. 5, 2006

(54) Method and apparatus for generating thin lines in video images

(75) Inventors: Erwin Bellers, Fremont, CA (US); Jan O.G. Caussyn, Maldegem (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/545,841

(22) PCT Filed: Dec. 10, 2003
(86) PCT No.: PCT/IB03/05991

§ 371 Date: Aug. 17, 2005

(51) Int. Cl. H04N 9/74; H04N 5/14; H04N 9/64

(52) U.S. Cl. 348/571; 348/581

(57) ABSTRACT

A method and apparatus for thinning lines in a video, includes providing a line signal (15) of a video, the line signal (15) having pair of spaced apart transitions (16) which slope toward one another and merge at an edge (17) of a first thickness, the first thickness of the edge generating a line of a given width in the video. At least one of the transitions (16) is moved toward a center of the edge (17), to produce a new line signal (18) having an edge (19) of a second thickness which is less than the first thickness, thereby reducing the given width of the line in the video.

This invention relates to video signal processing, and more particularly, to a method and apparatus for creating very thin lines or further thinning thin lines in video images to produce sharper video images.

Improvements in the perceived sharpness of a displayed video image are typically accomplished by processing the original video signal with one of two basic types sharpness enhancement techniques or methods: peaking and luminance transient improvement (LTI). The peaking method is a linear technique that selectively boots high frequencies within the image scene, without adding new high frequencies. This method creates “undershoots” and “overshoots” in the resulting line signal. A moderate amount of these undershoots and overshoots significantly help improve the subjective sharpness of the picture. However, if the quantity of the undershoots and overshoots are not well controlled, the picture quality becomes degraded. Moreover, this method does not make thin lines thinner, and may actually make thin lines appear wider or thicker.

The LTI method employs highly non-linear techniques that attempt to steepen the edges (transitions) in the video picture without introducing undershoots and overshoots, which are introduced by the peaking method. As such, truly new high frequencies are introduced into the displayed video image.

FIG. 1 illustrates the operation of the LTI method. Solid line 10 represents an original line signal and broken line 11 represents the line signal after LTI processing (new line signal). As shown, adjacent edge 12, the slope of each transition 13 is made steeper in the new line signal 11. Therefore, this method often yields a pleasing image with increased sharpness impression. However, the increased amount of luminance in the top of the new line signal 11 has a line thickness T2 which is greater than the line thickness T1 of the original line signal 10.

Accordingly, a sharpness enhancement method is needed, which creates very thin lines or further thins existing thin lines in video images to produce sharper video images.

The advantages, nature, and various additional features of the invention will appear more fully upon consideration of the illustrative embodiments now to be described in detail in connection with accompanying drawings where like numerals are used to identify like elements and wherein:

FIG. 1 graphically depicts a line signal which has been processed by a prior art luminance transient improvement method.

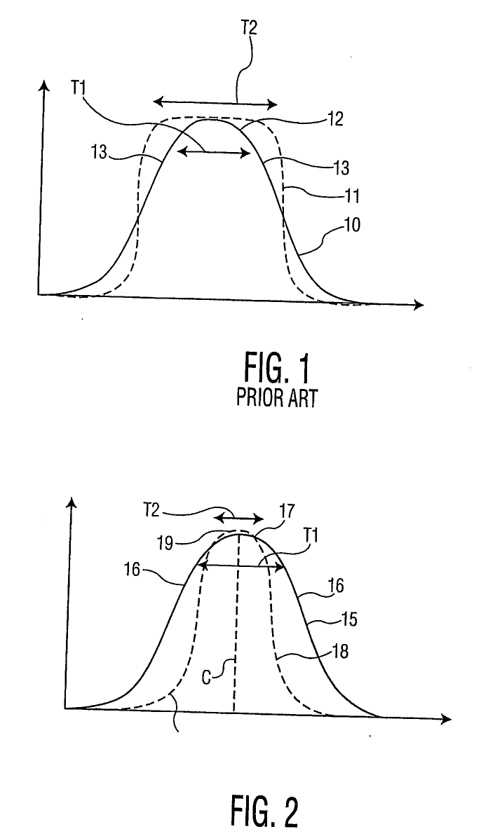

FIG. 2 graphically depicts a line signal which has been processed in accordance with the principles of the present invention.

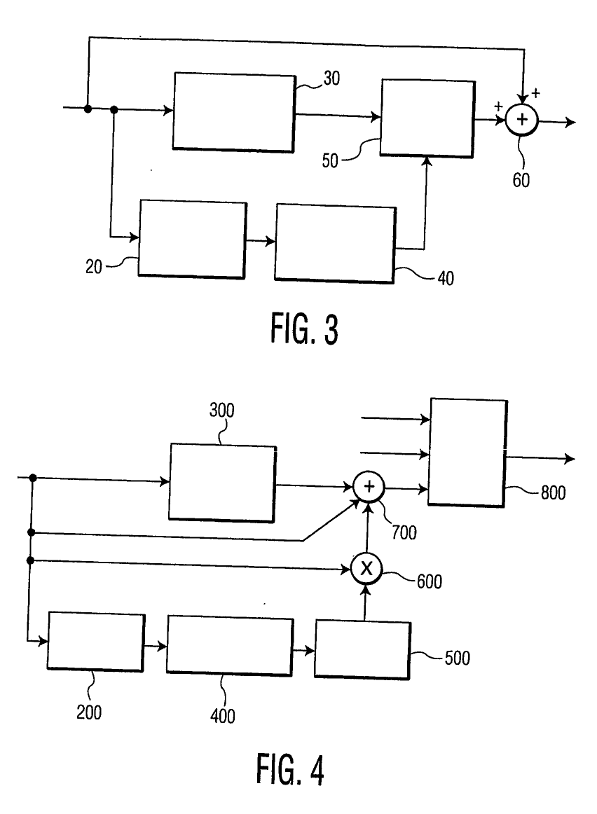

FIG. 3 is a block diagram of a thin lines generator/enhancement apparatus according to a first exemplary embodiment of the present invention.

FIG. 4 is a block diagram of a thin lines generator/enhancement apparatus according to a second exemplary embodiment of the present invention.

It should be understood that the drawings are for purposes of illustrating the concepts of the invention and are not necessarily to scale.

A method and apparatus for thinning lines in a video, comprises providing a line signal of a video, the line signal having pair of spaced apart transitions which slope toward one another and merge at an edge of a first thickness, the first thickness of the edge generating a line of a given width in the video. At least one of the transitions is moved toward a center of the edge, to produce a new line signal having an edge of a second thickness which is less than the first thickness, thereby reducing the given width of the line in the video.

The present invention is a method and apparatus for creating thin lines and/or further thinning thin lines (resulting in very thin lines) in video images to produce sharper vidco images. A “thin line” is defined herein as a line, line part, or curved line of a very limited width, e.g., a few pixels or less, or may depend upon application and personal taste. Scanning across an edge produces two transitions in pixel luminance value levels in close spatial proximity (in the order of a few samples or pixels) to one another, e.g., a transition from a black line to white followed by a transition from white to black, or a transition from black to grey followed by a transition from grey to white. The transition width is very limited, and mostly of the order of 1 to 4 pixels.

FIG. 2 graphically depicts an original (thin) line signal which has been processed in accordance with the present invention. Solid line 15 represents the original line signal. The invention achieves “line thinning” by shifting each transition 16 of the original line signal in the direction of the center C of edge 17 (in FIG. 2 this corresponds to the direction of increasing luminance), thereby positioning transitions closer to one another, and sometimes, steepening the slope of each transition 16. This process generates a new line signal 18 (shown with broken lines) having a line (edge 19) thickness T2 which is less than the line thickness T1 of the original line signal 15. Accordingly, thin lines and/or further narrowed thin lines can be generated, which creates the impression of increased sharpness in the video images.

FIG. 3 is a block diagram of a thin line generator according to a first exemplary embodiment of the present invention. A thin line detector 20 generates a thin line detection signal by performing a conventional thin line detection process on the original line signal, wherein each video image is scanned for lines which meet the above described criteria (i.e., lines, line parts, or curved lines of a very limited width). In one illustrative process, the thin line detection signal is generated only if both transitions are found in close proximity to one another. There are, of course, various other thin line detection processes that may be used for generating the thin line detection signal.

The original line signal is also utilized by a modification signal generator 30 to calculate a modification signal that will be applied to the original line signal (after sub-pixel shifting) to yield lines that are thinner than the lines in the original video images. The modification signal generator 30 may, for example, include using a non-linear luminance transient improvement (LTI) algorithm. A slope direction identifier 40 identifies the slope direction or angle of the detected lines in the thin line detection signal, i.e., vertical, horizontal, or any other slope angle in the spatial domain and generates a slope direction signal. In one exemplary embodiment, the slope direction identifier 40 searches in various directions, e.g., n number of angles with a 10 degree interval, for the line edges, where edge direction is defined by the edge that has the largest absolute change in pixel or sample values across the edge and the smallest absolute change in pixel or sample values along the edge. The slope direction identifier 40 may also use other methods for identifying the slope direction of the lines.

A sub-pixel shifter 50 receives the modification and slope direction signals and shifts the modification signal on a sub-pixel grid in accordance with a selected amount of steepness, which may be determined for example, by a combination of user preference and the found edge characteristic (direction and strength) in the slope direction signal. An adder 60 combines the shifted modification signal with the original line signal to produce the new line signal 17 of FIG. 2, which has the thin lines and/or further narrowed thin lines.

FIG. 4 is a block diagram of a thin line generator according to a second exemplary embodiment of the present invention. In this embodiment, the original line signal is applied to a peaking signal generator 300. The peaking signal generator 300 calculates a peaking signal from the original line signal. The peaking signal generator 300 may be implemented with a conventional highpass or bandpass filter device, or a combination of both. A thin line detector 200, which may be identical to the thin line detector described in first embodiment of FIG. 3, generates a thin line detection signal (detected lines or thin lines) using a conventional thin line detection process on the original line signal. A thin line type identifier 400 identifies the slope direction or angle of the detected lines in the thin line detection signal, i.e., vertical, horizontal, or any other slope angle in the spatial domain. This edge information is used by a gain factor determiner 500 to determine a gain factor. An amplifier 600 multiplies the original line signal with the gain factor to provide a thin line gain signal that has a relatively low amplitude, which is either added or subtracted (depending on the sign of the gain factor) to the sum of the peaking signal and the original line signal at adder 700. The thin line gain signal negatively or positively offsets the peaking signal, which respectively results in either thinner bright lines or thinner dark lines.

Because this process sometimes “over-corrects” the original line signal, i.e., produces desirable sharp and steep transitions with undesirable strong “undershoots” and “over-shoots”, the new or “corrected” line signal is further processed by a conventional median filter 800, which clips the new line signal between two predefined clipping levels limit1 and limit2. The predefined clipping levels may be the sample value at the beginning of the transition and the sample value at the end of the transition. The median filter 800 passes through the new line signal if its value is between limit1 and limit2. If the new line signal is not between limit1 and limit2, either the clipping level of limit1 or limit2 is selected (which is just the median of the three).

The second embodiment is simpler and less expensive to implement than the first embodiment as it eliminates the sub-pixel shift, meaning interpolation, of the first embodiment. In addition, the second embodiment is also easily capable of producing either thin dark lines or thin bright lines by simply adding or subtracting the peaking signal from the original line signal. The first embodiment is also easily capable of producing either thin dark lines or thin bright lines by shifting the corrected signal outwards.

The method and apparatus of the present invention may be implemented in a system such as a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. Such a system may include one or more video/image sources, one or more input/output devices, a processor and a memory. The video/image source(s) may represent, e.g., a television receiver, a VCR or other video/image storage device. The source(s) may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices, processor and memory may communicate over a communication medium. The communication medium may represent, e.g., a bus, a communication network, one or more internal connections of a circuit, circuit card or other device, as well as portions and combinations of these and other communication media. Input video data from the source(s) is processed in accordance with one or more software programs stored in memory and executed by processor in order to generate output video/images supplied to a display device.

In a preferred embodiment, the principles of the present invention may be implemented by computer readable code executed by the system. The code may be stored in the memory such as described above, or read/downloaded from a memory medium such as a CD-ROM or floppy disk. In other embodiments, hardware circuitry may be used in place of, or in combination with, software instructions to implement the invention. For example, the elements shown in FIGS. 3 and 4 may also be implemented as discrete hardware elements.

While the foregoing invention has been described with reference to the above embodiments, various modifications and changes can be made without departing from the spirit of the invention. Accordingly, such modifications and changes are considered to be within the scope of the appended claims.

1. A method of thinning lines in a video, the method comprising the steps of:
providing a line signal (15) of a video, the line signal (15) having pair of spaced apart transitions (16) which slope toward one another and merge at an edge (17) of a first thickness, the first thickness of the edge (17) generating a line of a given width in the video; and
moving at least one of the transitions (16) toward a center of the edge (17), to produce a new line signal (18) having an edge (19) of a second thickness which is less than the first thickness, thereby reducing the given width of the line in the video.

2. The method according to claim 1, wherein the moving step includes the steps of:
calculating an adjustment signal (30, 300) from the line signal (15); and
combining (60, 700) the adjustment signal with the line signal (15) to produce the new line signal (18).

3. The method according to claim 1, wherein the moving step includes the steps of:
calculating (30) a modification signal from the line signal (15); and
combining (60) the modification signal with the line signal (15) to produce the new line signal (18).

4. The method according to claim 1, wherein the moving step includes the steps of:
calculating (30) a modification signal from the line signal (15);
shifting (50) the modification signal in accordance with a selected amount of steepness to generate a shifted modification signal; and
combining (60) the shifted modification signal with the line signal (15) to produce the new line signal (18).

5. The method according to claim 1, wherein the moving step includes the steps of:
calculating (30) a modification signal from the line signal (15);
detecting (20) the line in the line signal (15);
identifying (40) a slope angle of the detected line;
shifting (50) the modification signal in accordance with a selected amount of steepness determined at least by the identified slope angle, to generate a shifted modification signal; and
combining (60) the shifted modification signal with the line signal (15) to produce the new line signal (18).

6. The method according to claim 1, wherein the moving step includes the steps of:
calculating (300) a peaking signal from the line signal (15); and
combining (700) the peaking signal with the line signal (15) to produce the new line signal (18).

7. The method according to claim 1, wherein the moving step includes the steps of:
calculating (300) a peaking signal from the line signal (15);
generating a thin line gain signal; and
combining (700) the thin line gain signal, the peaking signal, and the original line signal (15) to produce the new line signal (18).

8. The method according to claim 7, wherein the generating step includes the steps of:
detecting (200) the line in the line signal (15);
identifying (400) a slope angle of the detected line;
determining (500) a gain factor using the slope angle; and
multiplying (600) the line signal (15) with the gain factor.

9. The method according to claim 8, further comprising the step of clipping (800) the new line signal (18) between two predefined clipping levels.

10. The method according to claim 7, further comprising the step of clipping (800) the new line signal (18) between two predefined clipping levels.

11. An apparatus for thinning lines in a video, the apparatus comprising:
means (30, 300) for calculating an adjustment signal from a line signal (15) having pair of spaced apart transitions (16) which slope toward one another and merge at an edge (17) of a first thickness, the first thickness of the edge (17) generating a line of a given width in the video; and
means (60, 700) for combining the adjustment signal with the line signal (15) to move at least one of the transitions (16) toward a center of the edge (17), to produce a new line signal (18) having an edge (19) of a second thickness which is less than the first thickness, thereby reducing the given width of the line in the video.

12. The apparatus according to claim 11, wherein the calculating means (30) calculates a modification signal which comprises the adjustment signal.

13. The apparatus according to claim 12, further comprising means (50) for shifting the modification signal, prior to combining with the line signal (15).

14. The apparatus according to claim 13, further comprising:
means (20) for detecting the line in the line signal (15);
means (40) for identifying a slope angle of the detected line;
wherein the shifting means (50) shifts the modification signal in accordance with a selected amount of steepness determined at least by the identified slope angle.

15. The apparatus according to claim 11, wherein the calculating means (300) calculates a peaking signal which comprises the adjustment signal.

16. The apparatus according to claim 15, further comprising:
means for generating a thin line gain signal; and
means (700) for combining the thin line gain signal, the peaking signal, and the line signal (15) to produce the new line signal (18).

17. The apparatus according to claim 16, wherein the thin line gain signal generating means includes:
means (200) for detecting the line in the line signal (15);
means (400) for identifying a slope angle of the detected line; and
means (500) for determining a gain factor using the slope angle; and
means (600) for multiplying the line signal (15) with the gain factor to generate the thin line gain signal.

18. The apparatus according to claim 17, further comprising means (800) for clipping the new line signal (18) between two predefined clipping levels.

19. The apparatus according to claim 16, further comprising means (800) for clipping the new line signal (18) between two predefined clipping levels.

20. An memory medium for thinning lines in a video, the memory medium comprising:
code (30, 300) for calculating an adjustment signal from a line signal (15) having pair of spaced apart transitions (16) which slope toward one another and merge at an edge (17) of a first thickness, the first thickness of the edge (17) generating a line of a given width in the video; and
code (60, 700) for combining the adjustment signal with the line signal (15) to move at least one of the transitions (16) toward a center of the edge (17), to produce a new line signal (1 8) having an edge (1 9) of a second thickness which is less than the first thickness, thereby reducing the given width of the line in the video.

21. The memory medium according to claim 20, wherein the code (30) for calculating the adjustment signal calculates a modification signal which comprises the adjustment signal.

22. The memory medium according to claim 21, further comprising code (50) for shifting the modification signal, prior to combining with the line signal (15).

23. The memory medium according to claim 22, further comprising:
code (20) for detecting a line in the line signal (15);
code (40) for identifying a slope angle of the detected line;
wherein the code (50) for shifting the modification signal shifts the modification signal in accordance with a selected amount of steepness determined at least by the identified slope angle.

24. The memory medium according to claim 20, wherein the code (300) for calculating the adjustment signal calculates a peaking signal which comprises the adjustment signal.

25. The memory medium according to claim 24, further comprising:
code for generating a thin line gain signal; and
code (700) for combining the thin line gain signal, the peaking signal, and the line signal (15) to produce the new line signal (18).

26. The memory medium according to claim 25, wherein the code for generating the thin line gain signal includes:
code (200) for detecting a line in the line signal (15);
code (400) for identifying a slope angle of the detected line; and
code (500) for determining a gain factor using the slope angle;
code (600) for multiplying the line signal (15) with the gain factor to generate the thin line gain signal.

27. The memory medium according to claim 26, further comprising code (800) for clipping the new line signal (18) between two predefined clipping levels.

28. The memory medium according to claim 25, further comprising code (800) for clipping the new line signal (18) between two predefined clipping levels.
